(19) United States
(12) Patent Application Publication
(10) Pub. No.: US 2026/0077652 A1
(43) Pub. Date: Mar. 19, 2026

(54) PRE-CHARGING SYSTEM FOR A VEHICLE

(71) Applicant: Volvo Truck Corporation, GOTEBORG (SE)

(72) Inventors: Yann BOETE, Lyon (FR); Kamilla PEIXOTO, LYON (FR)

(21) Appl. No.: 18/887,596

(22) Filed: Sep. 17, 2024

(51) Int. Cl. B60L 1/02; H02J 7/00

(52) U.S. Cl. CPC B60L 1/02; H02J 7/44; H02J 7/445; H02J 7/855; H02J 7/96; B60L 2200/18; B60L 2200/36; B60L 2200/40; H02J 2207/10; H02J 2207/50

(57) ABSTRACT

A system for a vehicle, the system comprising: a low voltage input connectable to a low voltage system onboard the vehicle, wherein said low voltage is 24 V or 12 V; a capacitor of a batteryless 48 V system, the batteryless 48 V system comprising a 48 V electric machine arranged to generate power to an electrical exhaust heater onboard the vehicle; and an electrical circuit arranged between the low voltage input and the capacitor to pre-charge the batteryless 48 V system from the low voltage system.

### TECHNICAL FIELD

The disclosure relates generally to a system for a vehicle. In particular aspects, the disclosure relates to pre-charging a 48 V system comprising a 48 V electric machine arranged to generate power to an exhaust heater onboard a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In a conventional electrical 48 V system, there is a 48 V battery and a system to precharge the 48 V network, either by a battery feed or by a reversible DCDC.

### SUMMARY

According to a first aspect of the disclosure, a system for a vehicle, the system comprising: a low voltage input connectable to a low voltage system onboard the vehicle, wherein said low voltage is 24 V or 12 V; a capacitor of a batteryless 48 V system, the batteryless 48 V system comprising a 48 V electric machine arranged to generate power to an electrical exhaust heater onboard the vehicle; and an electrical circuit arranged between the low voltage input and the capacitor to pre-charge the batteryless 48 V system from the low voltage system. The first aspect of the disclosure may seek to ensure that energization is available for the 48 V electric machine to start generating power. A technical benefit of pre-charging the 48 V system from such a low voltage system onboard the vehicle may be that no 48 V battery is needed. A technical benefit of having a batteryless 48 V system may be reduced cost and/or size.

Optionally, in some examples, said capacitor is a (separate or standalone) component of the batteryless 48 V system. Alternatively, said capacitor could be the combined internal capacitance (or the sum of all capacitors) of the components of the batteryless 48 V system, such as the 48 V electric machine, any exhaust heater controller(s), possibly a separate capacitor, etc.

Optionally, in some examples, the electrical circuit may comprise an inductor and a diode (connected in series) between the low voltage input and the capacitor. A technical benefit of using an inductor may be reduced/low heat dissipation from the electrical circuit, which in turn means that less or no heat dissipation material is needed. Another technical benefit may be that the batteryless 48 V system can be pre-charged to >24 V even if the actual voltage of the 24 V system onboard the vehicle is below 24 V.

Optionally, in some examples, the system may further comprise a control module. The control module may be configured to control a current (needed to charge the capacitor) through the inductor using pulse width modulation (PWM). A technical benefit of this may be that the inductor may reduce the current increase rate, so that the peak current during the PWM on state stays below an accepted limit.

Optionally, in some examples, the control module may be configured to control the current through the inductor (using high side pulse width modulation) in accordance with a first sequence to charge the capacitor up towards 24 V.

Optionally, in some examples, the control module may be configured to control the current through the inductor (using low side pulse width modulation) in accordance with at least one second sequence to charge the capacitor above 24 V.

Optionally, in some examples, wherein the control module may have (at least one of): a first mode for discharging the inductor in the capacitor, a second mode for discharging the inductor in ground, a third mode for direct capacitor charging (for example from the low voltage input via the inductor), and a fourth mode for recharging the inductor.

Optionally, in some examples, the control module may comprise a high side switching element between the low voltage input and one end of the inductor and a low side switching element between the other end of the inductor and ground.

Optionally, in some examples, the diode may be connected in series between said other end of the inductor and the capacitor, wherein the diode may be arranged to conduct current to the capacitor, and wherein the drain of the low side switching element may be connected between said other end of the inductor and the diode.

Optionally, in some examples, in the first mode the high side switching element and the low side switching elements are off, wherein in the second mode the high side switching element is off and the low side switching element is on, wherein in the third mode the high side switching element is on and the low side switching element is off, and wherein in the fourth mode the high side switching element and the low side switching elements are on.

Optionally, in some examples, the first sequence may comprise the third mode followed by the first mode.

Optionally, in some examples, the at least one second sequence may comprise a transition sequence comprising the fourth mode followed by the second mode followed by the first mode.

Optionally, in some examples, the at least one second sequence may further comprise a boost sequence following the transition sequence, the boost sequence comprising the fourth mode followed by the third mode. A technical benefit of the boost sequence is decreased pre-charge time.

Optionally, in some examples, the electrical circuit may comprise a shunt resistor and a diode connected in series between the low voltage input and the capacitor.

Optionally, in some examples, the system comprises the 48 V system.

Optionally, in some examples, the system comprises the low voltage system.

According to a second aspect of the disclosure, a vehicle comprising the system according to the first aspect. The second aspect of the disclosure may seek to ensure that energization is available for the 48 V electric machine to start generating power. A technical benefit of pre-charging the 48 V system from such a low voltage system onboard the vehicle may be that no 48 V battery is needed. A technical benefit of having a batteryless 48 V system may be reduced cost and/or size.

According to a third aspect of the disclosure, a method for pre-charging a batteryless 48 V system comprising a 48 V electric machine arranged to generate power to an exhaust heater onboard a vehicle, the method comprising: pre-charging the batteryless 48 V system from a low voltage system onboard the vehicle via an electrical circuit arranged between the batteryless 48 V system and the low voltage system, wherein said low voltage is 24 V or 12 V. The third aspect of the disclosure may seek to ensure that energization is available for the 48 V electric machine to start generating power. A technical benefit of pre-charging the 48 V system from such a low voltage system onboard the vehicle may be that no 48 V battery is needed. A technical benefit of having a batteryless 48 V system may be reduced cost and/or size.

Optionally, in some examples, the electrical circuit may comprise an inductor and a diode between a low voltage (24 V or 12 V) input connected to the low voltage system and a stabilizing capacitor of the batteryless 48 V system. A technical benefit of using an inductor may be reduced/low heat dissipation from the electrical circuit, which in turn means that less or no heat dissipation material is needed. Another technical benefit may be that the batteryless 48 V system can be pre-charged to >24 V even if the actual voltage of the 24 V system onboard the vehicle is below 24 V.

Optionally, in some examples, pre-charging may comprise: controlling, by a control module of the vehicle, a current through the inductor in high side pulse width modulation (in accordance with a first sequence) to charge the capacitor up towards 24 V.

Optionally, in some examples, pre-charging may comprise: controlling, by a control module of the vehicle, the current through the inductor in low side pulse width modulation (in accordance with at least one second sequence) to charge the capacitor above 24 V.

Optionally, in some examples, a control module of the vehicle may have (at least one of): a first mode for discharging the inductor in the capacitor, a second mode for discharging the inductor in ground, a third mode for direct capacitor charging, and a fourth mode for recharging the inductor.

Optionally, in some examples, the electrical circuit may comprise a shunt resistor and a diode between a low voltage (e.g., 24 V) input connected to the low voltage system and a capacitor of the batteryless 48 V system.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a schematic view of a vehicle comprising a pre-charging system according to an example.

FIG. 2 is a circuit diagram of a pre-charging system according to an example.

FIG. 3A illustrates the pre-charging system in a first mode according to an example.

FIG. 3B illustrates the pre-charging system in a second mode according to an example.

FIG. 3C illustrates the pre-charging system in a third mode according to an example.

FIG. 3D illustrates the pre-charging system in a fourth mode according to an example.

FIG. 4 is a flowchart of a pre-charging method according to an example.

FIG. 5 is a schematic view of a vehicle comprising a pre-charging system according to an example.

FIG. 6 is another view of FIG. 1.

### DETAILED DESCRIPTION

The detailed description set forth below provides information and examples of the disclosed technology with sufficient detail to enable those skilled in the art to practice the disclosure.

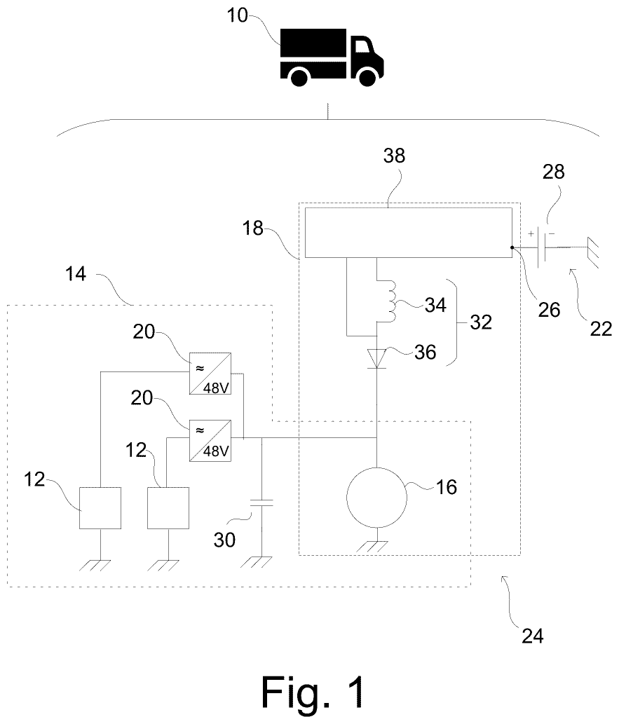

FIG. 1 is an exemplary vehicle 10 according to an example. The vehicle 10 may for example be a heavy-duty vehicle, such as a truck, a bus, or construction equipment.

The vehicle 10 may comprise at least one electrical exhaust heater 12, such as two electrical exhaust heaters 12. A technical benefit of electrical exhaust heaters 12 may be faster activation and reduced overall NOx on cycle.

The electrical exhaust heaters 12 may require a significant level of electrical energy, for example up to 10 kW, which is higher than what is achievable with a conventional alternator. To this end, the vehicle 10 may comprise a 48 V (48 Volt) system 14 to increase the power availability.

In addition to the at least one electrical exhaust heater 12, the 48 V system 14 may comprise a 48 V electrical machine 16 arranged to generate power to the at least one electrical exhaust heater 12. The 48 V electrical machine 16 may for example be a claw-pole motor. The 48 V electrical machine 16 may be coupled to engine 18 of the vehicle 10.

The 48 V system 14 may further comprise at least one exhaust heater controller 20. The at least one exhaust heater controller 20 may be arranged between the 48 V electrical machine 16 and the at least one electrical exhaust heater 12. The at least one exhaust heater controller 20 may be configured to control the level of power fed to the at least one electrical exhaust heater 12. The at least one exhaust heater controller 20 may for example be two exhaust heater controllers 20; one per electrical exhaust heater 12.

The 48 V electrical machine 16 may require energization on its B+ terminal to start providing energy. One way to provide the energization could be to include a 48 V battery.

However, to reduce cost and find a good packaging solution, the 48 V system 14 is preferably a batteryless 48 V system, i.e., without any 48 V battery. Instead, the 48 V system 14 may in the present disclosure be pre-charged from a 24 V (24 volt) system 22 onboard the vehicle. To this end, the vehicle 10 may comprise a (pre-charging) system 24.

The system 24 may comprise a 24 V input 26. The 24 V input 26 may be connected to the 24 V system 22 of the vehicle 10. The 24 V input 26 may for example be connected to a 24 V battery 28 of the 24 V system 22. The 24 V system 22 could further comprise at least one of a starter for the engine 18 and an alternator coupled to the engine 18, for example.

Alternatively, the system 22 could here be a 12 V system, and the input 26 could be a 12 V input.

The system 24 may further comprise a capacitor 30. The capacitor 30 may form part of the 48 V system 14. As such, the capacitor 30 may be referred to as a 48 V system capacitor. The capacitor 30 may be (electrically) connected to the 48 V electrical machine 16. The capacitor 30 may serve to stabilize the output voltage of the 48 V electrical machine 16. Hence, the capacitor 30 may be a stabilization capacitor. The capacitance of the capacitor 30 may for example be 100 mF or 120 mF.

The system 24 may further comprise an electrical circuit 32 arranged between the 24 V input 26 and the capacitor 30 to pre-charge the batteryless 48 V system 14 from the 24 V system 22. Optionally, in some examples, the electrical circuit 32 may comprise an inductor 34 and a diode 36. The inductor 34 and the diode 36 may be electrically connected in series between the 24 V input 26 and the capacitor 30. The inductance of the inductor 34 may for example be 100 μH.

The system 24 may further comprise a control module 38. The control module 38 may be configured to control a (capacitor charging) current through the inductor 34 by PWM. The current may be controlled by controlling the voltage applied to the inductor 34. In particular, the control module 38 may be configured to control the current through the inductor 34 in high side PWM in accordance with a first sequence to charge the capacitor up towards 24 V, and to control the current through the inductor 34 in low side PWM in accordance with at least one second sequence to charge the capacitor above 24 V (due to the fly-back effect of the capacitor 30 and freewheel diode 48), as will be discussed further hereinbelow. The at least one second sequence may comprise a transition sequence and optionally a subsequent boost sequence. The control module 38 may for example be or form part of an engine control module (ECM) for the engine 18.

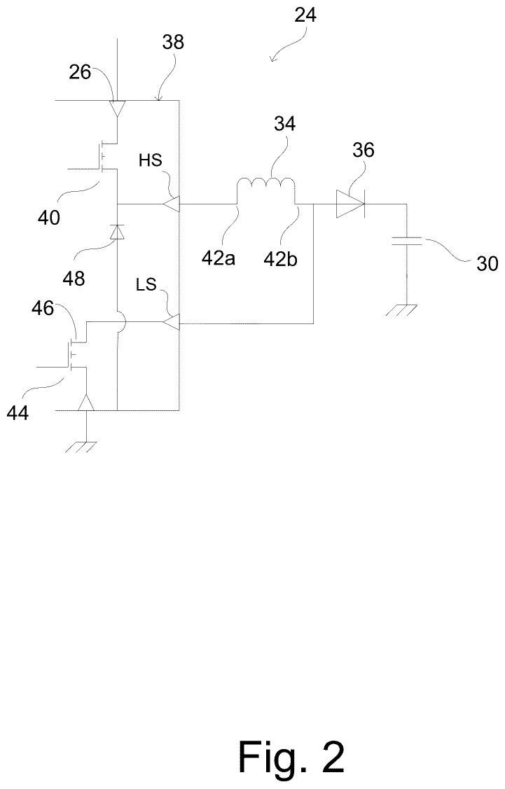

Turning to FIG. 2, the control module 38 may comprise the aforementioned 24 V input 26. Moreover, the control module 38 may comprise a high side (HS) switching element 40. The high side switching element 40 may be arranged between the 24 V input and one end 42a of the inductor 34. The high side switching element 40 may for example be a MOSFET (metal-oxide-semiconductor field-effect transistor), such as a N-channel MOSFET. The control module 38 may further comprise a low side (LS) switching element 44. The low side switching element 44 may be arranged between the other end 42b of the inductor 34 and ground. The low side switching element 44 may for example be a MOSFET, such as a N-channel MOSFET. The high side switching element 40 and the low side switching element 44 may be controlled in PWM independently. Moreover, a freewheel diode 48 may be arranged between the source of the high side switching element 40 and ground. The freewheel diode 48 may for example be a discrete diode in (the PCB) of the control module 38, or an integrated diode of the low side MOSFET 44, or a discrete diode separate from the control module 38.

The diode 36 may be connected (in series) between said other end 42b (of the inductor 34) and the capacitor 30. The diode 36 may be arranged to conduct current to the capacitor 30 from e.g., the inductor 34, but not from the capacitor 30 to e.g., the inductor 34. Moreover, drain 46 of the low side switching element 44 may be connected between said other end 42b (of the inductor 34) and the diode 36.

The control module 38 may have (or may be operable in) four modes: a first mode MODE1 for discharging the inductor 34 in the capacitor 30, a second mode MODE2 for discharging the inductor 34 in ground, a third mode MODE3 for direct capacitor 30 charging (e.g., from the 24 V input 26 via the inductor 34, or by discharging the inductor 34), and a fourth mode MODE4 useable for recharging the inductor 34.

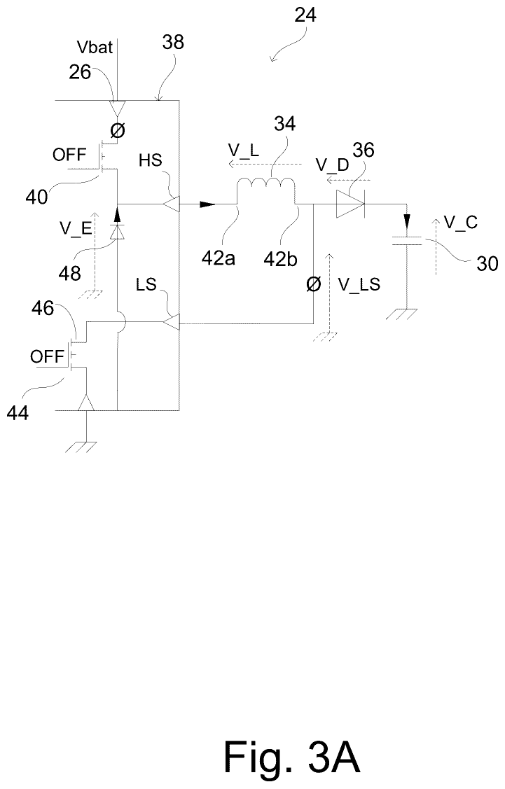

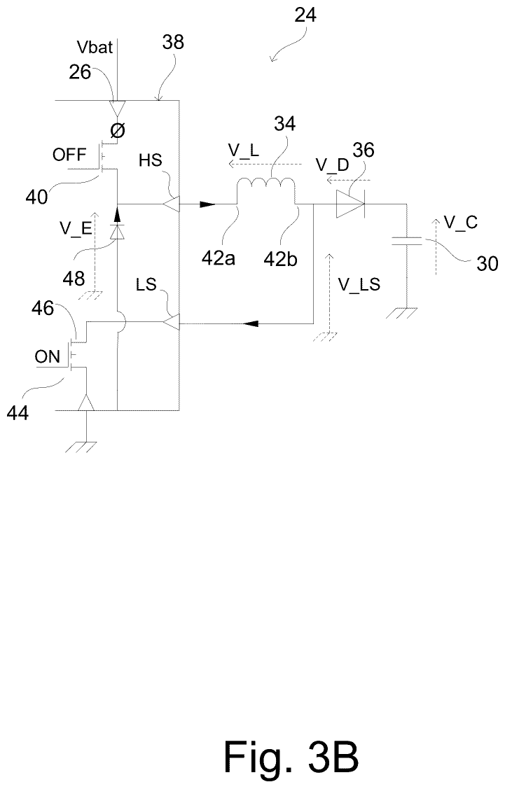

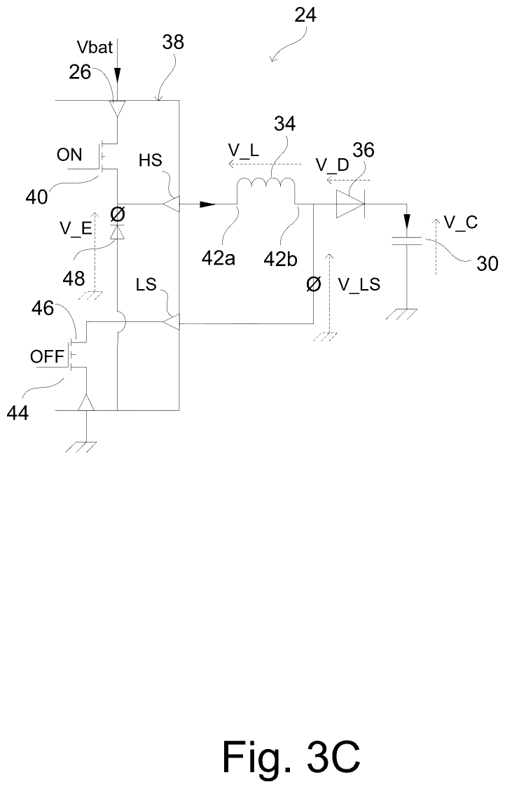

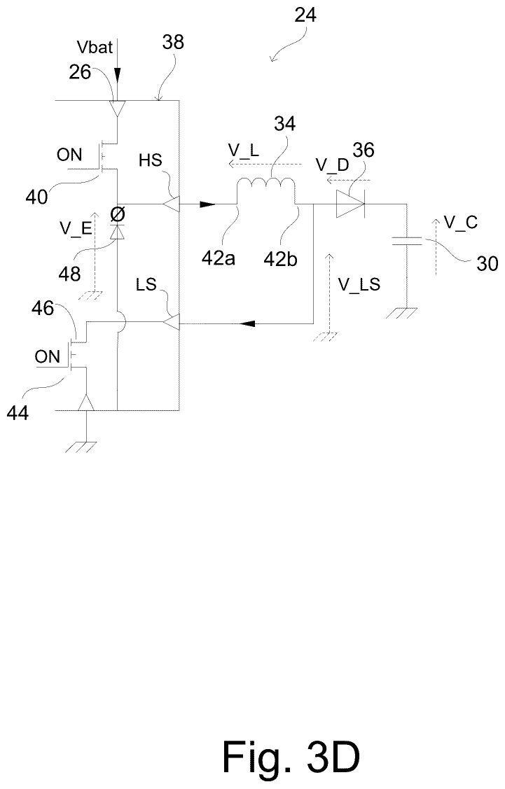

In the first mode MODE1, the high side switching element 40 and the low side switching elements 44 are both off (FIG. 3A). In the second mode MODE2, the high side switching element 40 is off and the low side switching element 44 is on (FIG. 3B). In the third mode MODE3, the high side switching element 40 is on and the low side switching element 44 is off (FIG. 3C). In the fourth mode MODE4, the high side switching element 40 and the low side switching elements 44 are both on (FIG. 3D).

The aforementioned first sequence to charge the capacitor 30 up towards 24 V may comprise the third mode MODE3 followed by the first mode MODE1. That is, in the first sequence, the control module 38 may be configured to switch between the third mode MODE3 and the first mode MODE1. In both the third mode MODE3 and the first mode MODE1, the low side switching element 44 is off. The first sequence may be referred to as buck operation. The control module 38 may be configured to repeatedly perform the first sequence (i.e., MODE3→MODE1→MODE3→MODE1 and so on).

During the third mode MODE3 (FIG. 3C) in the first sequence, current flows from Vbat/24 V input 26 to the capacitor 30 through the high side switching element 40, the inductor 34, and the diode 36, wherein Vbat is the voltage of the 24 V battery 28.

As long as V_LS−V_C>V_D, where V_D is the diode forward threshold voltage, current flows to the capacitor 30. As in line resistance is neglectable, the current will increase. It may be desired to keep the current i in a reasonable value to keep system cost down. It may be desired to have the maximum current Iₚₑₐₖ=5 A and PWM frequency>1000 hz (so dt<0.001 s).

$$V\_E = V\_C + V\_D + V\_L$$

$$V\_E = Vbat$$

$$VL = L \frac{di}{dt}$$

$$V\_D = forward voltage drop ( ∼ 0.7 V )$$

$$As i = C \cdot \frac{{dV}_{C}}{dt} with C ≅ 100 mF and i = {I}_{peak} = 5 A \to Voltage variation of 5 / 0.1 * 0.001 = 0.05 V$$

$$\frac{di}{dt} = \frac{1}{L} * ( Vbat - {V}_{C} - {V}_{D} )$$

$$Vbat = 24 V$$

| V_C (V) | 0 | 3 | 6 | 9 | 12 | 15 | 18 | 23.3 |
|---|---|---|---|---|---|---|---|---|
| di (kA/s) | 233 | 203 | 173 | 143 | 113 | 83 | 53 | 0 |
| 0→5 A dt (μs) | 21 | 25 | 29 | 35 | 44 | 60 | 94 | ∞ |

When V_C = 0 V (at start), to keep i ≤ Iₚₑₐₖ = 5 A, a dt ~20 μs is needed, so a PWM ratio of 2% with a frequency of 1000 Hz.

During the first mode MODE1 (FIG. 3A) in the first sequence, the initial current I₀ is at the Iₚₑₐₖ of the preceding MODE3 (FIG. 3C). Due to the derivative nature of current inside the inductor 34, a negative voltage will appear in the inductor 34 to continue current flowing (and decreasing) from the freewheel diode 48 to the capacitor 30 through the inductor 34 and the diode 36.

As long as V_LS−V_C>forward threshold voltage, current flow to the capacitor 30.

$$V\_E = V\_C + V\_D + V\_L$$

$$V\_E = - Forward voltage drop ( ∼ - 0.7 V )$$

$$VL = L ( di / dt )$$

$$V\_D = Forward voltage drop ( ∼ 0.7 V )$$

$$V\_C = assumed as 0 for the first iteration$$

$$\frac{di}{dt} = \frac{1}{L} * ( - {V}_{d} - {V}_{c} - {V}_{d} )$$

This variation of current is not dependent of Vbat.

$$\frac{di}{dt} = - 14 kA / s$$

As I₀ is assumed to be Ipeak (5 A), to have i going back to 0 will need 357 μs. This corresponds to 0.357×T with a base frequency of 1 kHz, so as long as the PWM ratio is below 64% (MODE3), there is enough time to go from Ipeak to zero. For reference, when PWM ratio is 64%, the MODE3 activation time is 640 μs. With a Ipeak target of 5 A, that correspond to increase rate of 7800 A/s. And with a Vbat of 24 V, it is a value that corresponds to V_C of 22.5 V. In other words, Vbat=24 V leads to V_C=22.5. Moreover, the control module 38 may (here) be configured to use an adaptative PWM frequency to reduce the time off and increase system speed. As shown in the table hereinabove, as the capacitor 30 starts charging, the difference of potential (voltage) between Vbat and V_C is smaller. That means there is a smaller di. Then, as the time passes, the peak of current decreases. So, the control module 38 can increase dt (the PWM duty cycle) while keeping i<Ipeak. Increasing dt accordingly to the increase of the voltage on the capacitor 30 will make the capacitor 30 charge faster.

When V_C (also referred to as V_{C}) becomes close to Vbat (for example Vbat-V_D=V_C), the control module 38 may change from the first sequence to the aforementioned at least one second sequence in response to V_C becoming close to Vbat. Specifically, the control module 38 may be configured to change from the first sequence to the transition sequence in response to V_C becoming close to Vbat. The transition sequence may be referred to as transition to boost mode.

When Vbat and V_C are close, the high side switching element 40 and the low side switch element 44 should be synchronized, to make sure that the control module 38 will be able to switch between the MODEs. The high side switching element 40 should not be kept on, as the current may increase above Ipeak. Therefore, the first mode MODE1 may be used to decrease the current to zero. Moreover, the control module 38 should not continue with the first sequence, because activation time could be too long and too sensitive to tune.

The transition sequence may comprise the fourth mode MODE4 followed by the second mode MODE2 followed by the first mode MODE1. The control module 38 may be configured to repeatedly perform the transition sequence (i.e., MODE4→MODE2→MODE1→MODE4→MODE2→MODE1 and so on).

During the fourth mode MODE4 (FIG. 3D) in the transition sequence, current flows from Vbat to ground through the inductor 34. As V_{LS}=0 V, the diode 36 is block, keeping the charge in the capacitor 30.

$$V\_E = V\_L + V\_LS$$

$$V\_E = Vbat$$

$$V\_L = L ( di / dt )$$

$$V\_LS = 0$$

$$\frac{di}{dt} = \frac{1}{L} * ( {V}_{bat} )$$

Rate of 240 kA/s. A very short activation time may be needed. To keep Ipeak<=5 A, a dt ˜20 μs is needed, so a PWM ratio of 2% with a frequency of 1000 Hz.

During the second mode MODE2 (FIG. 3B), energy is lost in the ground. The second mode MODE2 is merely a transition mode to synchronize the deactivation of the low side switching element 44 and the high side switching element 40. The second mode MODE2 should be keep it at minimum value, such as 1 μs. It can be noted that if the third mode MODE3 was used instead, as the capacitor voltage V_C is close to Vbat, rate would be low but still positive. And, as the current is already Ipeak, the current would be too high.

During the first mode MODE1 (FIG. 3A) in the transition sequence, current will continue to flow to the capacitor 30, regardless of the capacitor voltage value. The discharge time may be 640 μs (inductance of 100 μH), with the current going from 5 A to zero.

$$2.5 A \times 640 μ s = dQ$$

$$So dU = dQ / C = 16 mV at each pulse .$$

Thus, the capacitor voltage V_C will continue to increase.

When the capacitor voltage value is above Vbat, the above-mentioned issue of current increase in the third mode MODE3 will not exist. Therefore, the control module 38 may here change to a more efficient sequence, namely the boost sequence. In other words, the control module 38 may be configured to change (from the transition sequence) to the boost sequence in response to the voltage V_C of the capacitor 30 being or becoming greater than Vbat (i.e., 24 V). The boost sequence may be referred to as full boost mode.

The boost sequence may comprise the fourth mode MODE4 followed by the third mode MODE3. The control module 38 may be configured to repeatedly perform the boost sequence (i.e., MODE4→MODE3→MODE4→MODE3 and so on).

In the fourth mode MODE4 (FIG. 3D) in the boost sequence, the inductor 34 is recharged. The control module 38 may be configured to keep this fourth mode MODE4 activation short, for example 20 μs.

During the third mode MODE3 (FIG. 3C) in the boost sequence, current flows from Vbat to the capacitor 30 through the high side switching element 40, the inductor 34, and the diode 36. As the control module 38 switches to this third mode MODE3 from the fourth mode MODE4, I₀ is at Ipeak. Energy is stored in the inductor 34, and entering in the third mode MODE3 will release this energy in the capacitor 30.

$$V\_E = V\_C + V\_D + V\_L$$

$$V\_E = Vbat$$

$$VL = L ( di / dt )$$

$$V\_D = Forward voltage drop ( ∼ 0.7 V )$$

$$V\_C = assumed as constant and > Vbat$$

$$\frac{di}{dt} = \frac{1}{L} * ( {V}_{bat} - {V}_{c} - {V}_{d} )$$

$$Vbat = 24 V$$

| | | | | |
|---|---|---|---|---|
| V_C (V) | 24.5 | 25 | 25.5 | 26 |
| di (kA/s) | −12 | −17 | −22 | −27 |
| 5 →0 A dt | 417 μs | 294 μs | 227 μS | 185 μs |

Current will continue to flow to the capacitor 30, whatever the capacitor voltage value. The discharge time will depend on capacitor voltage (V_C). As the discharge time in the boost sequence is shorter than in the transition sequence, the control module 38 may use a higher PWM frequency, and so a faster boost.

It can be noted that the 48 V electrical machine 16 needs 24 V to start. However, if the 24 V battery 28 has exactly 24 V, it would not be possible because the circuit includes e.g., the voltage drop of the diode 36, and other internal losses. And there may be cases where the 24 V battery 28 is in a low charge state, where its voltage drops up to 22 V. So, the boost sequence will guarantee the 48 V electrical machine 16 will have enough power to start, no matter the condition of the 24 V battery 28.

When the capacitor 30 achieves a value higher than 24 V, which is the minimum value needed to start the 48 V electrical machine 16, the pre-charging may be turned off, i.e., the control module 38 will stay (permanently) in the first mode MODE1. And there will be a constant energy exchange between the capacitor 30 and the 48 V electrical machine 16. At first, the energy stored on the capacitor 30 will be supplied to the 48 V electrical machine 16. This will enable the 48 V electrical machine 16 to start generating power enough to keep the capacitor 30 charged and to supply the electrical exhaust heater(s) 12. Fluctuations presented on the output of the 48 V electrical machine 16 will be compensated by the capacitor 30. That way the capacitor 30 will be responsible for filtering the output of the 48 V electrical machine 16, making the 48 V system 14 as stable as possible.

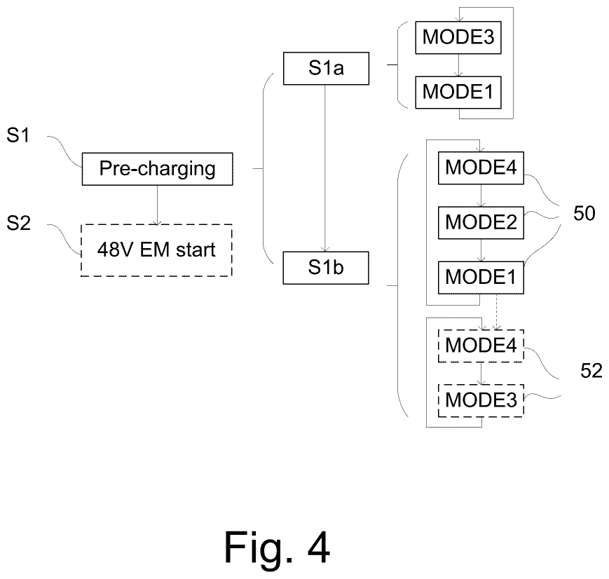

FIG. 4 is a flowchart of a method for pre-charging the batteryless 48 V system 14 comprising the 48 V electric machine 16 arranged to generate power to the at least one (electrical) exhaust heater 12 onboard the vehicle 10 according to an example. The method may correspond to operation of the system 24.

The method comprises pre-charging (step S1) the batteryless 48 V system 14 from the 24 V system 22 onboard the vehicle 10 via the electrical circuit 32 arranged between the batteryless 48 V system 14 and the 24 V system 22. The electrical circuit 32 may for example comprise the inductor 34 and the diode 36 between the 24 V input 26 connected to the 24 V system 22 and the stabilizing capacitor 30 of the batteryless 48 V system 14.

Step S1 may comprise controlling (step S1a), by the control module 38, a current through the inductor 34 in high side pulse width modulation in accordance with a recursion of the first sequence to charge the capacitor 30 up towards 24 V. As mentioned above, the first sequence may comprise the third mode MODE3 and the first mode MODE1.

Step S1 may further comprise controlling (step S1b, following step S1a), by the control module 38, the current through the inductor 34 in low side pulse width modulation in accordance with a recursion of each of the at least one second sequence to charge the capacitor 30 above 24 V. As mentioned above, the at least one second sequence may comprise the transition sequence 50 and optionally the boost sequence 52. The transition sequence 50 may comprise the fourth mode MODE4 followed by the second mode MODE2 followed by the first mode MODE1. The boost sequence 55 may comprise the fourth mode MODE4 followed by the third mode MODE3.

Following the pre-charging S1, energy stored on the capacitor 30 will be supplied to the 48 V electrical machine 16. This will enable the 48 V electrical machine 16 to start generating power (step S2) enough to keep the capacitor 30 charged and to supply the electrical exhaust heater(s) 12, as described hereinabove.

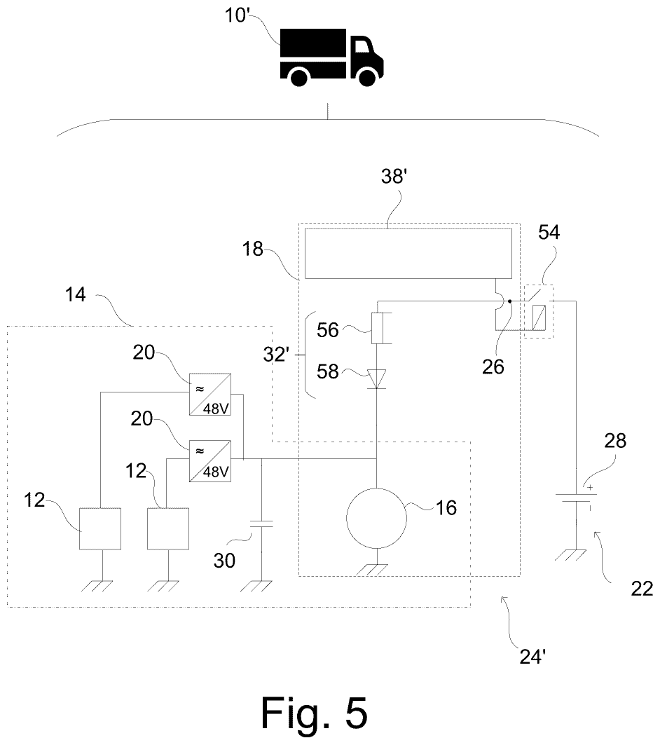

FIG. 5 is an exemplary vehicle 10′ according to an example. The vehicle 10′ may for example be a heavy-duty vehicle, such as a truck, a bus, or construction equipment.

The vehicle 10′ may comprise electrical exhaust heater(s) 12, such as two electrical exhaust heaters 12. A technical benefit of electrical (exhaust) heaters 12 may be faster activation and reduced overall NOx on cycle.

The electrical exhaust heaters 12 may require a significant level of electrical energy, for example up to 10 kW, which is higher than what is achievable with a conventional alternator. To this end, the vehicle 10′ may comprise 48 V (48 Volt) system 14 to increase the power availability.

In addition to the at least one electrical exhaust heater 12, the 48 V system 14 may comprise 48 V electrical machine 16 arranged to generate power to the at least one electrical exhaust heater 12. The 48 V electrical machine 16 may for example be a claw-pole motor. The 48 V electrical machine 16 may be coupled to engine 18 of the vehicle 10′.

The 48 V system 14 may further comprise exhaust heater controller(s) 20. The at least one exhaust heater controller 20 may be arranged between the 48 V electrical machine 16 and the at least one electrical exhaust heater 12. The at least one exhaust heater controller 20 may be configured to control the level of power fed to the at least one electrical exhaust heater 12. The at least one exhaust heater controller 20 may for example be two exhaust heater controllers 20; one per electrical exhaust heater 12.

The 48 V electrical machine 16 may require energization on its B+ terminal to start providing energy. One way to provide the energization could be to include a 48 V battery.

However, to reduce cost and find a good packaging solution, the 48 V system 14 is preferably a batteryless 48 V system, i.e., without any 48 V battery. Instead, the 48 V system 14 may in the present disclosure be pre-charged from 24 V (24 volt) system 22 onboard the vehicle. To this end, the vehicle 10′ may comprise a (pre-charging) system 24′.

The system 24′ may comprise 24 V input 26. The 24 V input 26 may be connected to the 24 V system 22 of the vehicle 10. The 24 V input 26 may for example be connected to 24 V battery 28 of the 24 V system 22 via a pre-charge relay 54. The 24 V system 22 could further comprise at least one of a starter for the engine 18 and an alternator coupled to the engine 18, for example.

The system 24′ may further comprise capacitor 30. The capacitor 30 may form part of the 48 V system 14. As such, the capacitor 30 may be referred to as a 48 V system capacitor. The capacitor 30 may be (electrically) connected to the 48 V electrical machine 16. The capacitor 30 may serve to stabilize the output voltage of the 48 V electrical machine 16. Hence, the capacitor 30 may be a stabilization capacitor. The capacitance of the capacitor 30 may for example be 100 mF or 120 mF.

The system 24′ may further comprise an electrical circuit 32′ arranged between the 24 V input 26 and the capacitor 30 to pre-charge the batteryless 48 V system 14 from the 24 V system 22. Optionally, in some examples, the electrical circuit 32′ may comprise a shunt resistor 56 and a diode 58. The shunt resistor 56 and the diode 58 may be electrically connected in series between the 24 V input 26 and the capacitor 30.

The system 24′ may further comprise a control module 38′. The control module 38′ may be configured to control the pre-charge relay 54 (open/close). The control module 38′ may for example be or form part of an engine control module (ECM) for the engine 18.

In operation, the control module 38′ may close the pre-charge relay 54 to pre-charge the 48 V system 14 due to the shunt resistor 56 and diode 58 from the 24 V system 22. As soon as the 48 V system 14 reaches 24 V, the 48 V electrical machine 16 is configured (or able) to bootstrap and raise the voltage to a targeted 48 V.

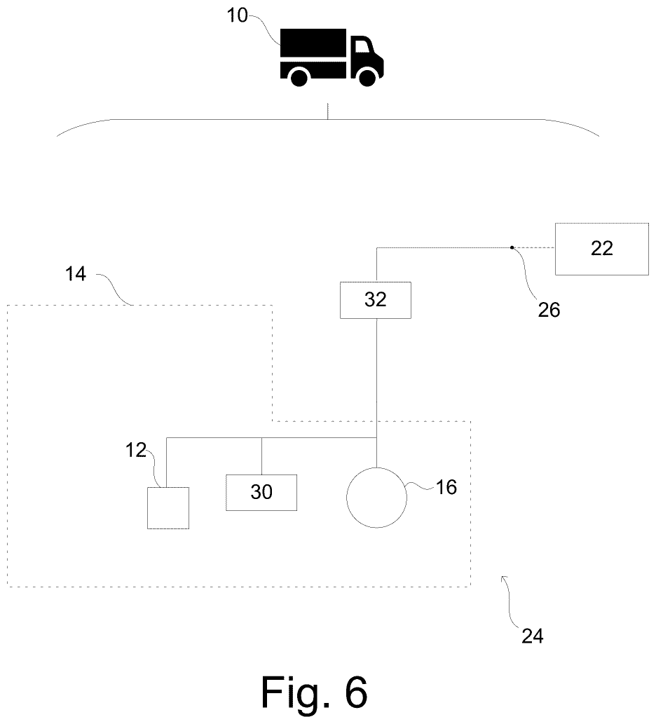

FIG. 6 is another view of FIG. 1, according to an example. FIG. 6 illustrates system 24 for vehicle 10, the system 24 comprising: low voltage input 26 connectable to low voltage system 22 onboard the vehicle 10, wherein said low voltage is 24 V or 12 V; capacitor 30 of batteryless 48 V system 14, the batteryless 48 V system 14 comprising 48 V electric machine 16 arranged to generate power to electrical exhaust heater 12 onboard the vehicle 10; and electrical circuit 32 arranged between the low voltage input 26 and the capacitor 30 to pre-charge the batteryless 48 V system 14 from the low voltage system 22.

Example 1: A system for a vehicle, the system comprising: a low voltage input connectable to a low voltage system onboard the vehicle, wherein said low voltage is 24 V or 12 V; a capacitor of a batteryless 48 V system, the batteryless 48 V system comprising a 48 V electric machine arranged to generate power to an electrical exhaust heater onboard the vehicle; and an electrical circuit arranged between the low voltage input and the capacitor to pre-charge the batteryless 48 V system from the low voltage system.

Example 2: The system of example 1, wherein the electrical circuit comprises an inductor and a diode connected in series between the low voltage input and the capacitor.

Example 3: The system of example 2, further comprising a control module configured to control a current through the inductor using pulse width modulation, PWM.

Example 4: The system of example 3, wherein the control module is configured to control the current through the inductor using high side pulse width modulation in accordance with a first sequence to charge the capacitor up towards 24 V.

Example 5: The system of example 3 or 4, wherein the control module is configured to control the current through the inductor using low side pulse width modulation in accordance with at least one second sequence to charge the capacitor above 24 V.

Example 6: The system of any of examples 3-5, wherein the control module has at least one of: a first mode for discharging the inductor in the capacitor, a second mode for discharging the inductor in ground, a third mode for direct capacitor charging, and a fourth mode for recharging the inductor.

Example 7: The system of any of examples 3-5, wherein the control module comprises a high side switching element between the low voltage input and one end of the inductor and a low side switching element between the other end of the inductor and ground.

Example 8: The system of example 7, wherein the diode is connected in series between said other end of the inductor and the capacitor, wherein the diode is arranged to conduct current to the capacitor, and wherein the drain of the low side switching element is connected between said other end of the inductor and the diode.

Example 9: The system of example 6 and 7, wherein in the first mode the high side switching element and the low side switching elements are off, wherein in the second mode the high side switching element is off and the low side switching element is on, wherein in the third mode the high side switching element is on and the low side switching element is off, and wherein in the fourth mode the high side switching element and the low side switching elements are on.

Example 10: The system of examples 4 and 6, wherein the first sequence comprises the third mode followed by the first mode.

Example 11: The system of examples 5 and 6, wherein the at least one second sequence comprises a transition sequence comprising the fourth mode followed by the second mode followed by the first mode.

Example 12: The system of example 11, wherein the at least one second sequence further comprises a boost sequence following the transition sequence, the boost sequence comprising the fourth mode followed by the third mode.

Example 13: The system of example 1, wherein the electrical circuit comprises a shunt resistor and a diode connected in series between the low voltage input and the capacitor.

Example 14: A vehicle comprising the system according to any of examples 1-13.

Example 15: A method for pre-charging a batteryless 48 V system comprising a 48 V electric machine arranged to generate power to an exhaust heater onboard a vehicle, the method comprising: pre-charging the batteryless 48 V system from a low voltage system onboard the vehicle via an electrical circuit arranged between the batteryless 48 V system and the low voltage system, wherein said low voltage is 24 V or 12 V.

Example 16: The method of example 15, wherein the electrical circuit comprises an inductor and a diode between a low voltage input connected to the low voltage system and a stabilizing capacitor of the batteryless 48 V system.

Example 17: The method of example 16, wherein pre-charging comprises: controlling, by a control module of the vehicle, a current through the inductor in high side pulse width modulation to charge the capacitor up towards 24 V.

Example 18: The method of example 16 or 17, where pre-charging comprises: controlling, by a control module of the vehicle, a current through the inductor in low side pulse width modulation to charge the capacitor above 24 V.

Example 19: The method of any of examples 16-18, wherein a control module of the vehicle has at least one of: a first mode for discharging the inductor in the capacitor, a second mode for discharging the inductor in ground, a third mode for direct capacitor charging, and a fourth mode for recharging the inductor.

Example 20: The method of example 15, wherein the electrical circuit comprises a shunt resistor and a diode between a low voltage input connected to the low voltage system and a capacitor of the batteryless 48 V system.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A system for a vehicle, the system comprising:
a low voltage input connectable to a low voltage system onboard the vehicle, wherein said low voltage is 24 V or 12 V;
a capacitor of a batteryless 48 V system, the batteryless 48 V system comprising a 48 V electric machine arranged to generate power to an electrical exhaust heater onboard the vehicle; and
an electrical circuit arranged between the low voltage input and the capacitor to pre-charge the batteryless 48 V system from the low voltage system.

2. The system of claim 1, wherein the electrical circuit comprises an inductor and a diode connected in series between the low voltage input and the capacitor.

3. The system of claim 2, further comprising a control module configured to control a current through the inductor using pulse width modulation, PWM.

4. The system of claim 3, wherein the control module is configured to control the current through the inductor using high side pulse width modulation in accordance with a first sequence to charge the capacitor up towards 24 V.

5. The system of claim 3, wherein the control module is configured to control the current through the inductor using low side pulse width modulation in accordance with at least one second sequence to charge the capacitor above 24 V.

6. The system of claim 3, wherein the control module has at least one of: a first mode for discharging the inductor in the capacitor, a second mode for discharging the inductor in ground, a third mode for direct capacitor charging, and a fourth mode for recharging the inductor.

7. The system of claim 3, wherein the control module comprises a high side switching element between the low voltage input and one end of the inductor and a low side switching element between the other end of the inductor and ground.

8. The system of claim 7, wherein the diode is connected in series between said other end of the inductor and the capacitor, wherein the diode is arranged to conduct current to the capacitor, and wherein the drain of the low side switching element is connected between said other end of the inductor and the diode.

9. The system of claim 6, wherein in the first mode the high side switching element and the low side switching elements are off, wherein in the second mode the high side switching element is off and the low side switching element is on, wherein in the third mode the high side switching element is on and the low side switching element is off, and wherein in the fourth mode the high side switching element and the low side switching elements are on.

10. The system of claim 6, wherein the first sequence comprises the third mode followed by the first mode.

11. The system of claim 6, wherein at least one second sequence comprises a transition sequence comprising the fourth mode followed by the second mode followed by the first mode.

12. The system of claim 11, wherein the at least one second sequence further comprises a boost sequence following the transition sequence, the boost sequence comprising the fourth mode followed by the third mode.

13. The system of claim 1, wherein the electrical circuit comprises a shunt resistor and a diode connected in series between the low voltage input and the capacitor.

14. A vehicle comprising the system according to claim 1.

15. A method for pre-charging a batteryless 48 V system comprising a 48 V electric machine arranged to generate power to an exhaust heater onboard a vehicle, the method comprising:
pre-charging the batteryless 48 V system from a low voltage system onboard the vehicle via an electrical circuit arranged between the batteryless 48 V system and the low voltage system, wherein said low voltage is 24 V or 12 V.

16. The method of claim 15, wherein the electrical circuit comprises an inductor and a diode between a low voltage input connected to the low voltage system and a stabilizing capacitor of the batteryless 48 V system.

17. The method of claim 16, wherein pre-charging comprises:
controlling, by a control module of the vehicle, a current through the inductor in high side pulse width modulation to charge the capacitor up towards 24 V.

18. The method of claim 16, where pre-charging comprises:
controlling, by a control module of the vehicle, a current through the inductor in low side pulse width modulation to charge the capacitor above 24 V.

19. The method of claim 16, wherein a control module of the vehicle has at least one of: a first mode for discharging the inductor in the capacitor, a second mode for discharging the inductor in ground, a third mode for direct capacitor charging, and a fourth mode for recharging the inductor.

20. The method of claim 15, wherein the electrical circuit comprises a shunt resistor and a diode between a low voltage input connected to the low voltage system and a capacitor of the batteryless 48 V system.
